(19) United States
(12) Patent Application Publication
(10) Pub. No.: US 2011/0071027 A1
(43) Pub. Date: Mar. 24, 2011

(54) HIGH STRENGTH AQUEOUS GLYPHOSATE SALT CONCENTRATES AND METHODS

(76) Inventors: Volker Heide, Memphis, TN (US); Marshall B. Wixson, Collierville, TN (US)

(21) Appl. No.: 12/562,656

(22) Filed: Sep. 18, 2009

(51) Int. Cl. A01N 57/18; A01P 13/00

(52) U.S. Cl. 504/206

(57) ABSTRACT

The present invention provides a high-strength glyphosate salt aqueous concentrate and a method for forming the concentrate. The method uses high purity and low water content glyphosate acid and primary amine preparations. The glyphosate acid and primary amine are reacted in the presence of a nominal amount of water. The method provides a concentrate with a very high concentration of biologically effective glyphosate salt, and a minimal amount of biologically ineffective glyphosate acid particulates. The minimal amount of particulates improves the viscosity of the concentrate to commercially acceptable levels, and the beneficial properties associated with the concentrate can be carried over into excipient-containing concentrates and application compositions that are formed from the high-strength glyphosate salt aqueous concentrate.

### FIELD OF INVENTION

The present invention is directed to high strength aqueous concentrate compositions that contain a primary amine salt of glyphosate.

### BACKGROUND

Glyphosate (N-phosphonomethyl glycine) is a well-known, non-selective herbicide that is commonly applied to control the growth of plants in a post-emergent manner. Glyphosate exhibits its herbicidal effects by inhibiting the shikimic acid pathway in plants. By inhibiting the shikimic acid pathway, the synthesis of aromatic amino acids and other secondary metabolites becomes obstructed. The obstruction disrupts protein synthesis, which ultimately results in plant death.

Aqueous glyphosate salt formulations have been preferred from a commercial standpoint. The acid form of glyphosate has a low solubility in water and therefore glyphosate is typically in salt form in aqueous compositions. In addition, glyphosate in salt form is significantly more biologically effective than glyphosate acid. Various salt forms of glyphosate, which can be used in aqueous compositions, have been described in the art (see, for example, U.S. Pat. Nos. 3,799,758, 4,140,513, 4,315,765, 4,481,026, and 4,507,250). In particular, aqueous compositions containing the monoisopropylamine (MIPA) salt of glyphosate have wide commercial use.

Some aqueous glyphosate salt compositions are sold in the form of concentrates. These concentrates are typically diluted prior to plant treatment and often include activity-enhancing surfactants. Surfactant-containing concentrates can be diluted by the end user to provide glyphosate application compositions.

Surfactant-containing concentrates are typically derived from manufacturer's concentrates, which generally contain a glyphosate salt at a high concentration. Glyphosate salt is generally present in these manufacturer's concentrates in the range of about 50-63 wt %. Unfortunately, there can be problems with these manufacturer's concentrates that are caused by methods associated with their preparation. For example, some methods of forming manufacturer's concentrates cause undesirable precipitates to form. These precipitates can make the concentrates difficult to work with. The precipitates can significantly increase the viscosity of the composition, which makes the composition difficult to measure and pump. In addition, and as a consequence of precipitate formation, the actual amount of the biologically active glyphosate salt in the concentrate is reduced, as well as the amount of the biologically active glyphosate salt that reaches the target organism. This can affect downstream uses of the manufacturer's concentrate. For example, the application composition may be misapplied because the end user may assume there is more glyphosate in the concentrate than actually present.

According to estimates from the U.S. Environmental Protection Agency, global herbicide use was approximately 2.0 billion pounds in 2000 and 2001. In the U.S., for combined agricultural and home applications, glyphosate was the most used herbicide in 2001. Improvements in glyphosate technology, particularly ones that allow for reductions in material handling, mixing, packaging, and freight, can have a significant impact on the carbon footprint associated with glyphosate use.

The current invention provides methods and compositions that not only offer technical advantages associated with glyphosate use, but that also are more environmentally friendly and economical.

### SUMMARY

Generally, the invention is directed to high-strength glyphosate salt aqueous concentrates (also herein “high-strength aqueous concentrates”). The invention is also directed to methods for forming these high-strength aqueous concentrates. High purity and low water content glyphosate acid and primary amine preparations are used as starting materials. The method involves preparing a glyphosate acid slurry with a limited amount of water, and then adding the primary amine preparation into the slurry so the acid and primary amine react and form a primary amine salt of glyphosate. The addition is carried out to maximize the amount of the primary amine salt of glyphosate that is formed. The method also minimizes the formation of undesirable particulates.

The resulting high-strength glyphosate salt aqueous concentrate formed has desirable characteristics. These desirable characteristics can be carried over into other high-strength glyphosate salt aqueous concentrates and application compositions. For example, the high-strength glyphosate salt aqueous can be used to form application compositions with improved biological activity. As such, less material may be needed to control plant growth.

The high-strength glyphosate salt aqueous concentrates of the invention therefore provide advantages that are reflected in one or more of the following reductions: material handling, mixing, packaging, and freight. By providing any one or more of these reductions, the carbon footprint associated with glyphosate use can accordingly be reduced. The method and compositions of the invention are therefore more environmentally friendly and economical.

In one aspect, the invention provides a method for preparing a high-strength glyphosate salt aqueous concentrate, wherein the glyphosate salt comprises a primary amine salt of glyphosate. The method includes a step of providing a glyphosate acid preparation having water content of 5 percent weight or less. Also, a primary amine preparation is provided comprising primary amine in amount of 98 percent weight or greater. The method also includes a step of combining water with the glyphosate acid preparation to provide a glyphosate acid slurry. The amount of water combined is in the range of 25% to 35% of a total amount of material from the glyphosate acid preparation and primary amine preparation used to form the high-strength glyphosate salt aqueous concentrate. The method also includes a step of adding the primary amine preparation to the glyphosate acid slurry to create a reaction mixture. In the reaction mixture the primary amine reacts with the glyphosate acid to form a primary amine salt of glyphosate, thereby producing a high-strength glyphosate salt aqueous concentrate.

In some aspects, the primary amine is monoisopropylamine (MIPA). Accordingly, the glyphosate salt that is formed in the high-strength aqueous concentrate is glyphosate-monoisopropylammonium (“glyphosate-MIPA”).

In more specific aspect, the step of adding the primary amine can utilize one or more of the following processing conditions: during the step of adding, keeping the mixture at a temperature in the range of 90° F. to below 140° F.; adding primary amine to the glyphosate acid slurry at a rate in the range of about 2.1% to about 3.2% per minute; adding the primary amine to the glyphosate acid slurry to provide a weight ratio of primary amine to glyphosate acid in the range of 0.27:1 to 0.33:1. After the step of adding, the high-strength glyphosate salt aqueous concentrate may also be subjected to one or more step(s) of filtering to remove particulates that are greater that 1 μm.

Also, after the high-strength glyphosate salt aqueous concentrate is formed additional water can be added to the concentrate. Additional water can be added to provide a second high strength concentrate with an amount of a primary amine salt of glyphosate that is similar to other manufacturer's concentrates. For example water is added to provide an amount of primary amine salt of glyphosate in the range of about 50 percent weight to about 70 percent weight.

The invention also provides high-strength glyphosate salt aqueous concentrates comprising a primary amine salt of glyphosate having properties beneficial for forming other high strength concentrates and application compositions. In one aspect, the invention provides a high-strength glyphosate salt aqueous concentrate comprising a primary amine salt of glyphosate in an amount of 50 percent weight or greater, wherein the concentrate comprises less than 1 percent weight unreacted glyphosate acid. In another aspect, the invention provides a high-strength glyphosate salt aqueous concentrate comprising a primary amine salt of glyphosate in an amount of 50 percent weight or greater, wherein the concentrate comprises less than 1 percent weight glyphosate particulates of a size greater than 1 μm. The high-strength glyphosate salt aqueous concentrates also have a viscosity of less than about 450 centistokes, such as in the range about 50 centistokes to less than about 450 centistokes.

The high-strength glyphosate salt aqueous concentrate formed by the method of the invention can be used to form other glyphosate-containing concentrate compositions, such as excipient-containing glyphosate salt aqueous concentrates. For example, one or more excipient(s) can be added to a high-strength aqueous concentrate. Excipient-containing glyphosate salt concentrates can display desirable properties, such as good viscosity and good storage stability, which are afforded by high-strength aqueous concentrate of the invention.

Starting with a high-strength aqueous concentrate, or an excipient-containing high-strength aqueous concentrate, herbicide application compositions can ultimately be formed. Application compositions, which are suitable for the direct application to foliage, can be prepared from the high-strength aqueous concentrate or excipient-containing glyphosate salt concentrates. Application compositions formed from the high-strength glyphosate salt aqueous concentrates, or excipient-containing glyphosate salt aqueous concentrates, display optimal biological activity when used to control plant growth.

### DETAILED DESCRIPTION

The embodiments of the present invention described herein are not intended to be exhaustive or to limit the invention to the precise forms disclosed in the following detailed description. Rather, the embodiments are chosen and described so that others skilled in the art can appreciate and understand the principles and practices of the present invention.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

Generally, the invention is directed to high-strength glyphosate salt aqueous concentrates (“high-strength aqueous concentrates”) that include a primary amine salt of glyphosate. The invention also provides methods for making high-strength aqueous concentrates. The invention is also directed to methods using the high-strength aqueous concentrates to make excipient-containing glyphosate salt concentrates. Ultimately, herbicide application compositions can be formed from the high-strength aqueous concentrates or excipient-containing glyphosate salt concentrates, and these herbicide application compositions can be useful for the control of plant growth.

Generally, in order to form the high-strength aqueous concentrates, a series of steps are carried out,which use a glyphosate acid preparation and a primary amine preparation. Both the glyphosate acid and primary amine preparations have high purities and low water contents. The high purity and low water content make it possible to drive the reaction between the glyphosate acid and the primary amine base to near completion. The high purities and low water contents also minimize formation of glyphosate acid particulates. These particulates otherwise form in the presence of impurities, particularly volatile liquid impurities such as formaldehyde and nitrosamines. Since glyphosate acid particulates contribute to higher viscosities and are considered a “biologically ineffective” form of glyphosate, the present method provides a distinct advantage for preparation of concentrates and application compositions with excellent herbicide bioactivity.

Using the high purity, low water content glyphosate acid preparation, a glyphosate acid slurry is prepared. The slurry is prepared using a limited amount of water (which can be measured relative to the total amount of glyphosate acid and primary amine reacted to form the primary amine salt of glyphosate). The primary amine is then added to the glyphosate acid slurry. In conjunction with the low levels of impurities present in the glyphosate acid and primary amine preparations, the low water content also facilitates that the reaction between the glyphosate acid and the primary amine base be driven near completion.

Additional method parameters, such as the temperature of the glyphosate acid and primary amine reaction mixture during the step of primary amine addition, the rate of addition of the primary amine to the reaction mixture, and agitation or the reaction mixture, can be chosen enhance the reaction of the glyphosate acid with the primary amine.

The method results in a high-strength aqueous concentrate having a very high concentration of primary amine salt of glyphosate dissolved in water. The glyphosate acid present in the high-strength aqueous concentrate is predominantly present in the form of biologically effective glyphosate acid, rather than in the form of biologically ineffective glyphosate acid particulates offset by impurities.

In aspects of the invention providing a high-strength aqueous concentrate wherein the presence of non-glyphosate salt components (other than water) are minimized, the method can consists of using (a) the glyphosate acid preparation comprising glyphosate acid and a having water content of 5 percent weight or less; (b) a primary amine preparation comprising a primary amine at 98 percent weight or greater; and (c) and an amount of water in the range of 25% to 35% of a total amount of material from the glyphosate acid preparation and primary amine preparations. In other words, in these aspects, the method does not include introducing materials other than the glyphosate acid preparation, the primary amine preparation, and water in the method for forming the high-strength aqueous concentrate.

After steps of the inventive method are carried out, the high-strength aqueous concentrate can be diluted with water to provide a concentration of glyphosate salt that is in the range of other manufacturer's concentrates. For example, the high-strength glyphosate salt concentrate can be diluted with water to a concentration in the range of about 50 percent weight to about 70 percent weight.

A high-strength aqueous concentrate of the invention can be described in terms of one or more of the following parameters: the concentration of the primary amine salt of glyphosate, the quantity of glyphosate acid particulates, the quantity of unreacted glyphosate acid, the very low levels or absence of impurities, and the viscosity.

In some aspects, the invention provides a high-strength glyphosate salt aqueous concentrate comprising a primary amine salt of glyphosate in an amount of 50 percent weight or greater, wherein the concentrate comprises less than 1 percent weight unreacted glyphosate acid, and has a viscosity of less than 450 centistokes.

In other aspects, the invention provides a high-strength glyphosate salt aqueous concentrate comprising a primary amine salt of glyphosate in an amount of 50 percent weight or greater, wherein the concentrate comprises less than 1 percent weight glyphosate particulates of a size greater than 1 μm and has a viscosity of less than 450 centistokes

In some aspects, the aqueous concentrate has a viscosity in the range of about 50 centistokes (cSt) to less than about 450 cSt, about 100 cSt to about 375 cSt, about 150 cSt to about 300 cSt, about 175 cSt to about 275 cSt, or about 200 cSt to about 250 cSt.

In more specific aspects, the concentration of the glyphosate salt in the high-strength aqueous concentrate is about 51 percent weight or greater, about 53 percent weight or greater, about 55 percent weight or greater, about 57 percent weight or greater, about 61 percent weight or greater, about 63 percent weight or greater, about 65 percent weight or greater, about 65 percent weight or greater, about 67 percent weight or greater, or about 68 percent weight or greater, such as in the range of about 51 percent weight to about 70 percent weight, about 53 percent weight to about 70 percent weight, about 55 percent weight to about 70 percent weight, about 57 percent weight to about 70 percent weight, about 59 percent weight to about 70 percent weight, about 61 percent weight to about 70 percent weight, about 63 percent weight to about 70 percent weight, or about 65 percent weight to about 70 percent.

The high-strength aqueous concentrate is typically in the form of a clear, homogeneous salt solution. Typically, the high-strength aqueous concentrate does not include excipient component(s) (e.g., a surfactant) in any appreciable amount(s).

Accordingly, in aspects of the invention providing a high-strength aqueous concentrate wherein the presence of non-glyphosate salt components (other than water) are minimized, the invention provides a high-strength glyphosate salt aqueous concentrate consisting essentially of a primary amine salt of glyphosate in an amount of 63 percent weight or greater, and either (a) less than 1 percent weight unreacted glyphosate acid or (b) less than 1 percent weight glyphosate particulates of a size greater than 1 μm. In other words, in these aspects, the high-strength aqueous concentrates do not include materials other than the primary amine salt of glyphosate, a minimal amount unreacted glyphosate acid (or glyphosate particulates or impurities), and water, in any substantial amount.

On the other hand, an “excipient-containing aqueous concentrate,” refers to an aqueous concentrate including a primary amine salt of glyphosate at high concentration and one or more herbicidally-useful excipient component(s). Excipient-containing concentrates can be prepared by adding one or more herbicidally-useful excipient component(s) to the high strength aqueous concentrate. Generally, the one or more herbicidally-useful excipients are added in an amount so the composition is maintained in a “concentrate” form.

Generally, a “concentrate” is a composition that is diluted with a volume of a dilution liquid (e.g., water) of more than one times the volume of the concentrate. In other words, a concentrate of the invention is diluted about 1:1 with water, or greater, for the preparation of a herbicide application compositions. More typically, excipient-containing aqueous concentrates are diluted with an amount of water at a ratio in the range of about 1:10 to about 1:20 to form a herbicide application composition.

The terms “glyphosate acid” and “glyphosate”, as used herein, refer to fully protonated or deprotonated forms of the acid. Glyphosate acid has the structure:

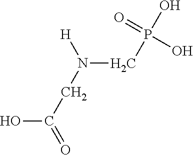

(C₃H₈NO₅P), a molecular weight of 169.1 Da, and the chemical name N-(phosphonomethyl)glycine. Glyphosphate in acid form has a very low solubility in water (about 12 g/L at 25° C.). On the other hand, most salt forms of glyphosate are at least very soluble in water. The acid dissociation constants for glyphosate are pKa₁ 0.8 (first phosphonic), pKa₂ 2.3 (carboxylate), pKa₃ 6.0 (second phosphonic), and pKa₄ 11.0 (amine). In an aqueous solution, glyphosate has a tendency to dissociate one proton from the phosphonic acidic group and associate that proton with the amine group, forming a dipolar molecule (zwitterion).

In order to prepare a high-strength aqueous concentrate, a high purity, low water content glyphosate acid preparation is provided. The glyphosate acid preparation can be a product of any particular known synthetic processes for preparing glyphosate acid. Various routes for the synthesis of glyphosate acid are known in the art.

One route, the “glycine route,” involves the phosphonomethylation of glycine. For example, chloromethyl-phosphonic acid can be reacted with glycine in basic conditions. In another glycine route, dimethyl phosphate is reacted with glycine to form glyphosate.

Another route is the catalytic oxidation of N-(phosphonomethyl)iminodiacetic acid (PMIDA) (see, for example, U.S. Pat. No. 3,954,848). The PMIDA route generally involves mixing PMIDA with water and an acid (such as sulfuric acid), and then heating the mixture to an elevated temperature. An oxidizing agent (such as an inorganic peroxide, like hydrogen peroxide, or an organic peroxide) is then added, which oxidatively converts iminodiacetic acid to glyphosate acid. Oxidation can be performed in the presence of a noble metal catalyst such as platinum, immobilized on a support. Precipitation of glyphosate acid can be achieved by precipitation, using a water-miscible organic solvent. Decomposition products observed using the PMIDA route can include glyphosine, glycine, iminodiacetic acid, M-formylglyphosate, PMIDA, (aminomethyl)phophonic acid (APMA), N-methyl-N-(phosphonomethyl glycine (MePMG), and N-N bis(phosphonomethyl)amine (bPMNH).

Glyphosate can also be produced by the phosphonomethylation of N-benzylglycine to N-benzyl glyphosate, followed by reaction with hydrobromic or hydroiodic acid to cleave the benzyl group, which produces glyphosate (see U.S. Pat. No. 3,956,370). Glyphosate can also be produced by the phosphonomethylation of N-t-butyl glycine to form N-t-butyl glyphosate, which is then converted to glyphosate via acid hydrolysis. Processes using N-benzylglycine or N-t-butylglycine as starting materials can produce byproducts such as isobutylene and toluene.

The glyphosate acid preparation used to form the high-strength aqueous concentrate has a water content of about 5 percent weight or less. In some aspects, the glyphosate acid preparation used to prepare the high-strength aqueous concentrate has a water content of about 4% wt or less, about 3% wt or less, or about 2% wt or less. For example, in some aspects the glyphosate acid preparation has a water content in the range of about 0.01% wt to about 5% wt, or more specifically in the range of about 0.01% wt to about 2% wt. The water content is the amount of water by weight of all material (liquid and solid) present in the glyphosate acid preparation. For example, in 100 g of a glyphosate acid preparation having a water content of 5% wt, there is 95 g of solids and 5 g of water.

The low water content significantly reduces the amount of water-soluble impurities or liquid impurities that are associated with the glyphosate acid preparation. For example, by using a glyphosate acid preparation with a water content of 5 percent weight or less, impurities such as formaldehyde and nitrosamines are substantially removed. (Examples of nitrosamine impurities include N-nitrosodialkylamines, wherein the alkyl is methyl, ethyl, propyl, or butyl, and N-nitrosopiperidine, N-nitrosopyrrolidine, and N-nitrosomorpholine). Carbon is another impurity that may be associated with preparations of glyphosate acid. These types of impurities are though to nucleate formation of undesirable glyphosate acid particulates. By removing these particulates, it significantly minimizes particulate formation, which in turn results in a high-strength aqueous concentrate with improved properties. These improved properties include good viscosity and a high concentration of glyphosate in the biologically effective form. For example, in some aspects, the glyphosate acid preparation has less than 1 percent weight formaldehyde, and/or less than 1 percent weight nitrosamines.

In some aspects, the glyphosate acid preparation used to form the high-strength aqueous concentrate includes glyphosate acid at 98 percent weight of total solids, or greater, or 99 percent weight of total solids, or greater. For example, as a percentage of the solids in the composition, the total non-glyphosate solids are present in the glyphosate acid preparation used in an amount in the range of about 0.01 percent weight to about 2 percent weight, or more specifically in the range of about 0.01 percent weight to about 1 percent weight.

Generally, a glyphosate acid preparation having a very low water content (e.g., about 5% wt or less) is in the form of a dry material (e.g., a dry flake or pellet), whereas a glyphosate acid preparation having a higher water content (e.g., about 10% wt) is in the form of a wet cake.

If desired, in order to lower the amount of moisture, the glyphosate acid preparation can be subjected to a low-pressure environment, heat, blown air, or combinations thereof. This can also be helpful in driving off volatile impurities, such as formaldehyde and nitrosamines. A low-pressure treatment can be performed prior to combining the glyphosate acid with the primary amine salt.

A primary amine preparation is also used to form the high-strength aqueous concentrate. A primary amine preparation refers to an amine base of the general formula: H₂NR, wherein R is a linear or branched alkyl radical having 2-6 carbon atoms. Examples of primary amines useful for forming a glyphosate primary amine salt in an aqueous concentrate include monoisopropyl amine, mono-n-propylamine, and monobutylamine.

The primary amine preparation used to form the glyphosate salt of the high-strength aqueous concentrate also has high purity. In the primary amine preparation, any non-primary amine component(s) are present in an amount of, about 5 percent weight or less, about 2 percent or less, or about 1 percent weight or less.

In a preferred mode of practice, the primary amine base used to form the glyphosate salt is monoisopropyl amine (MIPA, also IPA or isopropylamine). MIPA is a highly hygroscopic colorless liquid that is miscible with water. In some aspects the primary amine preparation has a water content of about 5% or less, such as in the range of about 0.01% wt to about 5% wt, about 0.01% wt to about 2% wt, or about 0.01% wt to about 1% wt. Accordingly, the amount of the primary amine in the primary amine preparation is about 98% wt or greater, such as in the range of about 98% wt to about 99.9% wt, or about 99% wt to about 99.9% wt.

In the process of preparing the high-strength aqueous concentrate, the glyphosate acid and the primary amine are reacted in a limited amount of water. Preferably, purified water is used. Purified water for the composition can come from, for example, a filtration process, a deionization process, or a distillation process.

The method of preparing the high-strength aqueous concentrate includes a step of combining water with the glyphosate acid preparation to form a glyphosate acid slurry. After the slurry is formed, primary amine is added to the slurry, which reacts with the glyphosate acid. The amount of water that is combined to form the slurry can be described relative to the total amount of glyphosate acid and primary amine used to form the high-strength aqueous concentrate. In the step of forming the slurry, an amount of water in the range of about 25% to about 35% of a total amount of material from the glyphosate acid preparation and primary amine preparation is combined with the glyphosate acid preparation. For example, if 200 g of the glyphosate acid preparation and 60 g of primary amine preparation is used to make the concentrate (260 g total material), an amount of water from about 65 g up to about 91 g can be combined with the glyphosate acid preparation to form the glyphosate acid slurry. In more specific aspects, an amount of water in the range of about 27.5% to about 32.5% of a total amount of material from the glyphosate acid preparation and primary amine preparation is combined with the glyphosate acid preparation.

The recited ranges of water can also take into account any pre-existing water carried over from the starting glyphosate acid and/or primary amine preparations. The greater the moisture content in the glyphosate acid and/or primary amine preparations, the less water will be needed to be combined with the glyphosate acid and primary amine ingredients to form the high-strength aqueous concentrate.

In the step of combining, purified water can be combined with the glyphosate acid preparation. Since glyphosate acid has a low solubility in water, the addition of water can transform the glyphosate acid preparation from a dry flake into an aqueous slurry, which generally is in the form of a thick suspension of solids in a liquid. (After the addition of the primary amine base, the slurry or suspension is transformed into a clear concentrate by the reaction of the base with the acid, and formation of the glyphosate salt.) If desired, mixing equipment can be used to facilitate preparation of the slurry. During and/or after combining the water the glyphosate acid, the slurry can be maintained at a desired temperature. For example, the slurry is maintained at a temperature of below about 120° C. (below about 49° C.). Lower temperatures can be useful, since the next step of adding the primary amine is understood to result in an exothermic reaction.

Next, a primary amine preparation is added to the glyphosate acid slurry. The step of addition results in a “reaction mixture” of glyphosate acid with the primary amine base, which results in the formation of the primary amine salt of glyphosate in a high strength aqueous concentrate. The reaction, in essence, transforms the low solubility glyphosate acid into the highly soluble glyphosate salt, which is solubilized by the water in the reaction mixture.

Typically, the addition of the primary amine is carried out using mixing or some form of agitation to facilitate the rapid distribution and reaction of the primary amine with the glyphosate acid in the mixture. Mixing can also help ensure that the heat generated by the exothermic reaction becomes more evenly distributed throughout the mixture.

During addition of the primary amine, the reaction mixture can be treated so that it is maintained within a desired temperature range. Typically, the reaction mixture is cooled since addition of primary amine is understood to result in an exothermic reaction. In some aspects, the reaction mixture is cooled to a temperature in the range of about 90° F. to below about 140° F. (about 32° C. to below about 60° C.), in the range of about 90° F. to about 120° F. (about 32° C. to about 49° C.), or in the range of about 105° F. to about 120° F. (about 40.5° C. to about 49° C.).

The primary amine can be added to the glyphosate acid slurry at a rate that drives reaction of the glyphosate acid with the primary amine towards completion, and promotes complete or substantially complete formation of the glyphosate salt. The rate of addition of the primary amine can be chosen based on one or more factors, such as the temperatures of the ingredients being combined, the batch size of the high strength aqueous concentrate to be made, as well as the rate of any mixing or agitation that is performed while the primary amine is added to the slurry of glyphosate acid.

In some modes of practice, the primary amine is added to the slurry of glyphosate acid at a rate in the range of about 2.1% to about 3.2% per minute. This rate can be calculated by the amount of primary amine added to the glyphosate slurry per minute divided by the total amount of primary amine and glyphosate acid used to make the high strength aqueous concentrate. For example, if 100 kg of glyphosate acid and 41.7 kg of primary amine are used to make the high strength aqueous concentrate, and if primary amine is added to the glyphosate acid slurry at 3.54 kg/min, the rate of addition would be 2.5% per minute.

A preferred primary amine base is monoisopropyl amine (MIPA). MIPA is in liquid form at temperatures lower-than 32° C., and can be metered into the glyphosate acid slurry.

Generally, an amount of primary amine is added to the glyphosate acid slurry to facilitate a high rate of reaction with the glyphosate acid. In some aspects, the primary amine is added in a molar excess relative to the glyphosate acid. For example, an amount of primary amine can be added to provide a molar ratio of glyphosate acid to primary amine in the range of about 1:1 to about 1:1.2, respectively. In the case of a high-strength aqueous concentrate of glyphosate-MIPA, glyphosate acid is added in a mass amount of about three times that of MIPA (i.e., a 3:1 weight ratio, such as 75 g of glyphosate acid and 25 g of MIPA), which falls within the molar range.

Generally, greater than 90 percent of the glyphosate acid in the glyphosate acid slurry reacts with the primary amine to form the primary amine salt of glyphosate.

After the primary amine is added, the reaction results in glyphosate acid being converted into a glyphosate salt (for example, glyphosate-MIPA), wherein glyphosate salt is in soluble form in the high-strength aqueous concentrate. At this point, the concentration of glyphosate salt can be very high, such as about 75 percent weight or greater, for example, between about 75 percent weight to about 80 percent weight.

This high-strength aqueous concentrate can then be diluted with water to provide a “second” high-strength aqueous concentrate that has a glyphosate salt at a concentration commonly found in commercial use. For example, an amount of water added can provide a second high-strength aqueous concentrate with a glyphosate salt concentration in the range of 60% wt to about 75% wt, about 63% wt to about 70% wt, about 65% wt to about 70% wt, or about 67% wt to about 70% wt.

The high-strength aqueous concentrate (or more dilute second high strength concentrate) can also be analyzed to determine properties such as viscosity, quantity of unreacted glyphosate acid, and the presence and quantity of particulates. In order to determine the effectiveness of the method of forming the high strength aqueous concentrate, analysis can be carried out before any optional supplemental treatment of the high-strength aqueous concentrate (such as filtration, which can further improve the quality of the high-strength aqueous concentrate).

Because of the high purity of reagents used to form the high-strength aqueous concentrate, the amount of unreacted glyphosate acid and/or particulates is very low. If any unreacted glyphosate acid is present, it typically is in the form of a glyphosate acid particulate, which is considered a biologically ineffective component of a herbicide composition.

The presence and amount of glyphosate acid particulates can be determined using common techniques. For example, the presence of particulates can be determined microscopically, or by using a flow cytometer. The quantity of particulates can be determined using centrifugation. For example, a sample of the high-strength aqueous concentrate can be subjected to centrifugation to pellet glyphosate acid particulates. Sedimentation centrifugation is a common technique for removing particles in a selected size distribution from a suspension of fine solids in liquids. The high-strength aqueous concentrate with soluble glyphosate salt can be decanted, and then the pellet can be weighed to determine the quantity of particulates relative to a volume of high-strength aqueous concentrate, or relative to the amount of glyphosate salt in the high-strength aqueous concentrate.

In some aspects the method of the invention produces a high-strength aqueous concentrate with an amount of particulates having a size of about 1 μm or greater, in an amount of about 1 percent of the weight, or less, of the glyphosate salt in the concentrate.

The pH of the high-strength aqueous concentrate can also be determined using standard techniques. In some aspects, the high-strength aqueous concentrate has a pH in the range of about 3 to about 6, or more specifically in the range of about 4 to about 4.8.

The viscosity of the high-strength aqueous concentrate can be determined using standard techniques. Test guidelines for viscosity measurement can be carried out according to EPA guideline 830.7100. Equipment for determination of viscosity can include, for example, a Brookfield Viscometer LVT, with a number 3 spindle. The speed setting knob can be placed at 60/3, and the high-strength aqueous concentrate can be measured at room temperature. A method for forming the high-strength aqueous concentrate as described herein can minimize particulate formation, which accordingly improves the viscosity since particulates contribute to higher composition viscosities.

The high-strength aqueous concentrate (or more dilute second high strength concentrate) can optionally be subjected to additional treatment(s) to improve the quality of the concentrate. For example, the high-strength aqueous concentrate can be subjected to one or more filtration steps. The filtration steps can remove particulates that may be present in the high-strength aqueous concentrate. Since the method of the invention already results in a low particulate level (without supplemental treatment) that, in turn, provides good viscosity, and makes the high-strength aqueous concentrate is easier to filter.

One or more optional steps of filtration, in turn, can further improve properties of the high-strength aqueous concentrate, such as by further lowering its viscosity.

A filtration step can include the use of a coarse filter to remove large particulates. Exemplary coarse filters have pore sizes in the range of about 10 to 200 microns. Generally, a 10 micron filter will trap particulates having a smallest dimension of about 10 microns or greater on the filter, while allowing particles of smaller to flow through. (Particulates have spherical and cubical shapes generally have their largest dimension on the order of their smallest dimension, whereas the smallest dimension of rod shaped particles corresponds to their width, not length.)

A coarse filter can be used with vacuum filtration to pull the high-strength aqueous concentrate through the filter and remove the particulates. In some aspects, filtration is performed while the high-strength aqueous concentrate is still very warm, for example at a temperature in the range of about 95° F. to about 113° F. (about 35° C. to about 45° C.).

Another treatment involves the use of a fine filter to remove smaller particulates such as those that flow through the large filter. For example, the high-strength aqueous concentrate can be filtered through a fine filter having a pore size of about 1 micron. A fine filter can be used in a single filtration step of the high-strength aqueous concentrate, or can be used to remove smaller particulates following coarse filtration. Fine filtration can therefore further reduce the amount of particulates that are present in the aqueous concentrate.

The high-strength aqueous concentrate can be used to form excipient-containing aqueous concentrates containing a primary amine salt of glyphosate. Excipient-containing aqueous concentrates can include one or more excipient(s). Excipients are also referred to in the art as adjuvants. The one or more excipients can be added to the high-strength aqueous concentrate in an amount so the excipient-containing aqueous concentrate remains in concentrated form.

One class of excipients that can be added to the high strength aqueous composition are surfactants. In some modes of forming the excipient-containing aqueous concentrate, a process is carried out so that a nominal amount of water is introduced into the high strength concentrate along with surfactant. Minimizing the amount of water during addition of an excipient introduced provides an excipient-containing aqueous concentrate where a higher concentration of the primary amine glyphosate salt is maintained. To accomplish this, surfactant can be added in a concentrated form.

In some cases surfactant is added in “neat” form, meaning that there are at most trace amounts of non-surfactant material(s) present along with surfactant. Surfactants can be in solid or liquid neat forms. In other cases, a surfactant composition that includes a diluent, such as water and/or one or more other liquids, is added to the high strength aqueous concentrate to form an excipient-containing aqueous concentrate.

A single surfactant type, or a combination of two or more different surfactants, can be used to form the excipient-containing aqueous concentrate from the high strength aqueous concentrate. In some cases, an amount of surfactant is added to the high strength aqueous concentrate so the concentration of the glyphosate salt does not fall below about 50 percent weight.

Types of surfactants that can be present in the excipient-containing aqueous concentrate include cationic surfactants, anionic surfactants, non-ionic surfactants, ionic surfactants, and amphoteric surfactants. Combinations of two or more surfactants can be used to form the excipient-containing aqueous concentrate.

An exemplary excipient-containing aqueous concentrate is described with regards to an alkoxylated alkyl amine surfactant. However, any known surfactant, or combination of surfactants, can be combined with the glyphosate salt to form an excipient-containing aqueous concentrate.

Exemplary alkoxylated alkyl amine surfactants include those having the formula R¹NR²R³, wherein R¹ includes a hydrocarbon group having 8 or more carbon atoms, and R² and R³ are independently selected from oxyalkylene polymeric chains. In some aspects R¹ is a C₈₋₂₂ alkyl group. In some aspects R² and R³ are respectively represented by (R⁴—O)ₘ—X and (R⁴—O)ₙ—X, wherein in R² and R³, R⁴ is independently C₂₋₄ alkene, and m and n have a combined value in the range of 2 to about 50.

Exemplary alkoxylated alkyl amine surfactants include polyoxyalkylene derivatives of tallowamine, cocoamine, and oleoylamine. In preferred aspects of the alkoxylated alkyl amine surfactant is polyoxyalkylene tallow amine. In preferred aspects the alkoxylated alkyl amine surfactant has 2 to about 15 ethylene oxide groups (EO) per amine, or from about 5 to about 10 EO groups per amine.

Commercially available alkoxylated alkyl amine surfactants include, for example, Ethomeen™ C/15, Ethomeen™ T/15, and Ethomeen™ T/20 (Akzo Nobel).

Another surfactant type that can be present in the excipient-containing aqueous concentrate is a quaternary ammonium-based surfactant. Quaternary ammonium surfactants include those with alkylation, ethoxylation, or propoxylation, or combinations thereof. Exemplary quaternary ammonium surfactant are commercially available under the trademarks Ethoquad™ and Arquad™ (AkzoNobel, Chicago, Ill), EMCOL™ CC (Witco Chemical). Quaternary ammonium glycoside surfactants are also described in JP 4-193891 and WO 99/10462.

Another surfactant type that can be present in the excipient-containing aqueous concentrate is an alkyl glycoside, which including alkyl polyglucosides (APGs). Alkyl glycosides include several commercial surfactants collectively known in the art or referred to herein as “alkyl polyglucosides” or “APGs”. Exemplary alkyl glycoside are Agrimul™ PG-2069 (Henkel), Agrimul™ PG-2076, and Eucarol™ AGE.

Another surfactant type that can be present in the excipient-containing aqueous concentrate is an alkoxylated phosphate ester, such ethoxylated phosphate esters. Examples include phosphate esters of alkylphenoxy polyethoxyethanol, and phosphate esters of alkylphenol ethoxylates. Commercially available ethoxylated phosphate ester surfactants include Stepfac™ 8170 (Stepan Co., Northfield, Ill.) and Emphos™ (Witco Chemicals, of Brooklyn, N.Y.)

Another surfactant type that can be present in the aqueous concentrate is an alkyldimethylamine. Examples include cocodimethylamine, tallowdimethylamine, dodecyldimethylamine. Commercially available alkyldimethylamines include Armeen™ DM12D (AkzoNobel) as Noram™ DMC or DMS (Ceca) respectively.

Another surfactant type that can be used in the present in the excipient-containing aqueous concentrate is a disulfonate surfactant. Examples of disulfonate surfactants include salts of alkyl diphenyl ether disulfonates and salts of alkyl diphenyl oxide disulfonates. Exemplary disulfonates include Dowfax 3B2™ (Dow Chemicals, Midland, Mich.) and Fenopon C0436™ (GAF Corp., New York, N.Y.).

Another surfactant type that can be used in the present in the excipient-containing aqueous concentrate is a poloxamer (a polyalkylene derivative of propylene glycol), such as Pluronic F68™ (BASF, Parsippany, N.J.).

Other surfactant types that can be present in the excipient-containing aqueous concentrate are alkylbetaines and alkyletherbetaines. Specific examples of an alkylbetaines is cocobetaine, available as Velvetex™ AB-45 (Henkel) or Tego™ Betaine F 50 (Goldschmidt).

As an example, an amount of a surfactant, such as an alkoxylated alkyl amine surfactant, is added to the high strength aqueous concentrate so the concentration of the primary amine salt of glyphosate does not fall below about 50 weight percent. Exemplary concentration ranges of the primary amine salt of glyphosate in the excipient-containing aqueous concentrate are from about 50 weight percent to about 60 weight percent. Ranges of surfactant are from about 1 weight percent to about 10 weight percent. An exemplary storage-stable, low viscosity, excipient-containing aqueous concentrate includes about 58 weight percent of the primary amine salt of glyphosate, and about 6 weight percent surfactant.

Optionally, excipients other than a surfactant(s) can be included in an excipient-containing aqueous concentrate. However, if included, they are desirably kept at lower concentrations to allow for a very high concentration of the primary amine salt of glyphosate in the excipient-containing aqueous concentrate. Alternatively, these optional excipients can be introduced into an application composition when the liquid concentrate is diluted prior to use.

Examples of other excipient that can be included in excipient-containing aqueous concentrate or herbicide application composition include other agriculturally acceptable excipients commonly used in formulated agricultural products. These include, but are not limited to antifoam agents, compatibilizing agents, sequestering agents, neutralizing agents and buffers, corrosion inhibitors, dyes, odorants, penetration aids, wetting agents, spreading agents, dispersing agents, thickening agents, freeze point depressants, antimicrobial agents, and crop oil, and the like.

An “application composition” refers to a diluted form of the excipient-containing aqueous concentrate which has a glyphosate salt concentration useful for controlling the growth of, or killing one or more desired plant species. To provide an application composition, the excipient-containing aqueous concentrate can be diluted with water to provide for a desired application concentration of glyphosate salt. The application concentration of glyphosate salt can be chosen by one or more factors, such as the type of vegetation to be treated, the rate of application of the application composition, and the use of one or more other excipients which may enhance the function of the glyphosate salt, or improve properties of the application composition.

The application composition can then be applied to foliage of plants to be killed or controlled. Spraying is a common method for applying the application compositions to foliage. For application, the application composition can be applied in any convenient volume of water. Typical ranges are from about 50 l/ha to 1,000 l/ha. Common rates of application for glyphosate (a.e.) are at a rate in the range of about 0.1 to about 5 kg/ha.

The herbicide application compositions are highly effective against a variety of weeds, including dicot and monocot weed species. Weed varieties include, but are not limited to kochia, ryegrass, sedge (cyperus), pigweed, foxtail, barnyard grass, quack grass, wild oat, wild poinsettia, velvet leaf, morning glory, lambs quarter, and sicklepod.

Additional secondary composition, including surfactant-containing compositions, application compositions, and methods for controlling the growth of plant are discussed in the U.S. non-provisional application filed Sep. 18, 2009, titled “Low Viscosity, Aqueous Glyphosate Salt Concentrates,” bearing attorney docket no. HAI0002/US, in the names of inventors including Heide, Volker, and Wixson, Marshall.

What is claimed is:

1. A method for preparing a high-strength glyphosate salt aqueous concentrate comprising steps of:
(a) providing a glyphosate acid preparation comprising glyphosate acid and a having water content of 5 percent weight or less;
(b) providing a primary amine preparation comprising a primary amine at 95 percent weight or greater;
(c) combining water with the glyphosate acid preparation to provide a glyphosate acid slurry, wherein the amount of water combined is in the range of 25% to 35% of a total amount of material from the glyphosate acid preparation and primary amine preparation added in step (d); and
(d) adding the primary amine preparation to the glyphosate acid slurry, wherein the primary amine reacts with the glyphosate acid to form a primary amine salt of glyphosate, thereby producing a high-strength glyphosate salt aqueous concentrate.

2. The method of claim 1, further comprising a step of adding additional water to provide a high-strength glyphosate salt aqueous concentrate comprising the primary amine salt of glyphosate in an amount in the range of 50% weight to 70% weight, wherein adding additional water is performed after step (d).

3. The method of claim 1, wherein on completion of step (d), greater than 90 percent of the glyphosate acid in the glyphosate acid slurry reacts with the primary amine to form the primary amine salt of glyphosate.

4. The method of claim 1, wherein glyphosate acid is present in the glyphosate acid preparation at 99 percent weight of total solids, or greater, and wherein the glyphosate acid preparation has a water content of 2 percent weight or less.

5. The method of claim 1, wherein the primary amine is present in the primary amine preparation at 99 percent weight or greater.

6. The method of claim 1, wherein step (c) the amount of water combined is in the range of 27.5% to 32.5% of a total amount of material from the glyphosate acid preparation and primary amine preparation combined in step (d).

7. The method of claim 1, wherein step (d), primary amine is added to the to the glyphosate acid slurry at a rate in the range of 2.1% to 3.2% per minute.

8. The method of claim 1, wherein step (d), the temperature is kept in the range of 90° F. to below 140° F.

9. The method of claim 8, wherein step (d), the temperature is kept in the range of 90° F. to 120° F.

10. The method of claim 9, wherein step (d), the temperature is kept in the range of 105° F. to 120° F.

11. The method of claim 1, wherein the primary amine preparation comprises monoisopropylamine.

12. The method of claim 11, wherein step (d), the primary amine preparation is added to the glyphosate acid slurry to provide a weight ratio of primary amine to glyphosate acid in the range of 0.27:1 to 0.33:1

13. The method of claim 1, further comprising a step of filtering the high-strength glyphosate salt aqueous concentrate, wherein filtering is performed after step (d).

14. The method of claim 13, wherein the step of filtering comprises removing particulates that are greater that 1 μm.

15. The method of claim 1, wherein step (d) is performed in a period of time in the range of 15 to 25 minutes.

16. The method of claim 1, wherein step (d) is performed with agitation of the glyphosate acid slurry as the primary amine is added.

17. The method of claim 1, wherein all or a portion of the glyphosate acid preparation is provided by a glyphosate-acid synthesis process comprising catalytic oxidation of N-(phosphonomethyl)iminodiacetic acid (PMIDA).

18. The method of claim 1, wherein the glyphosate acid preparation has one or more of the following features: less than 1 percent weight formaldehyde, less than 1 percent weight nitrosamines.

19. A high-strength glyphosate salt aqueous concentrate prepared according to the method of claim 1.

20. A high-strength glyphosate salt aqueous concentrate comprising a primary amine salt of glyphosate in an amount of 50 percent weight or greater, wherein the concentrate comprises less than 1 percent weight unreacted glyphosate acid and has a viscosity of less than 450 centistokes.

21. A high-strength glyphosate salt aqueous concentrate comprising a primary amine salt of glyphosate in an amount of 50 percent weight or greater, wherein the concentrate comprises less than 1 percent weight glyphosate particulates of a size greater than 1 μm and has a viscosity of less than 450 centistokes.
